(19) United States
(12) Patent Application Publication
(10) Pub. No.: US 2020/0410415 A1
(43) Pub. Date: Dec. 31, 2020

(54) COMPUTER-BASED SYSTEMS FOR RISK-BASED PROGRAMMING

(71) Applicant: Wells Fargo Bank, N.A., San Francisco, CA (US)

(72) Inventors: David Harris, Huntersville, NC (US); Jeanine Qasim, Charlotte, NC (US); Richard P. Gagan, Charlotte, NC (US); Nilakshana M. Jayanetti, Matthews, NC (US)

(21) Appl. No.: 15/877,783

(22) Filed: Jan. 23, 2018

(51) Int. Cl. G06Q 10/06

(52) U.S. Cl. CPC G06Q 10/0635; G06Q 10/067

(57) ABSTRACT

Techniques are described for correlating risk information and providing notifications to different devices based on the correlated risk information. An example computing device includes a memory, one or more processors, and a communication unit. The memory stores input data and a risk data model with respect to the input data. The processor(s) evaluate the input data for first risk information associated with a first remote device, and correlate the first risk information to second risk information to form a risk correlation, based on one or more characteristics of the input data. The processor(s) also determine that the second risk information is associated with a second remote device that is different from the first remote device, and generate a notification that includes information linking the second risk information to the input data. The communication unit transmits the notification to the second remote device.

### TECHNICAL FIELD

This disclosure generally relates to computer-based systems configured to predict operational risks related to a business policy or process.

### BACKGROUND

Enterprise computing systems generally identify business risks or operational risks based on results of certain business processes. A particular business process may introduce various types of operational risks to a business entity or even to multiple business entities that are in some way connected in relation to the business process. Various forms of operational risks include reputational risk, legal risk, credit risk, and the like.

### SUMMARY

In general, this disclosure describes computer-based systems configured/programmed on a specific risk, instead of on a business process that may result in the specific risk. Existing risk identification models may be useful within the closed universe of a given business, in a siloed manner. However, the existing risk identification models may make it difficult to identify risk correlations between different business silos, such as between different business units within a firm (e.g., business units under the umbrella of a financial institution entity), or across an industry (e.g., across different business entities within the financial industry).

The computer-based systems of this disclosure are configured to correlate a specific risk to other processes that may experience repercussions from the same specific risk. In some examples, the computer-based systems of this disclosure are configured to generate a specific risk data model for each specific risk, and to identify data inputs that may create or lead to that specific risk. The computer-based systems of this disclosure may also identify one or more controls, which, as used herein, refer to resiliency-based process actions that might mitigate or potentially even eliminate the repercussions that could result from a triggering of the specific risk.

In some examples, the data inputs to the risk data model may represent one or more of regulations, numbers, or data points from across one or more business units or business entities. A specific risk data model is configured to continually monitor the data inputs and the controls, and to output risk predictions, including likelihood of the specific risk and related impacts. The computer-based systems of this disclosure are also configured to generate a notification of the risk prediction, and to communicate the notification via a user-facing communication interface, thereby notifying an administrator of the risk prediction information.

In one example, this disclosure is directed to a computing device that includes a memory, one or more processors in communication with the memory, and a communication unit. The memory is configured to store input data and a risk data model with respect to the input data. The one or more processors are configured to evaluate the input data stored to the memory for first risk information associated with a first remote device, and to correlate the first risk information to second risk information to form a risk correlation, based on one or more characteristics of the input data. The one or more processors are further configured to determine that the second risk information is associated with a second remote device that is different from the first remote device, and to generate a notification that includes information linking the second risk information to the input data. The communication unit is configured to transmit the notification to the second remote device.

In another example, this disclosure is directed to a method that includes storing, to a memory, input data and a risk data model with respect to the input data, and evaluating, by one or more processors, the input data stored to the memory for first risk information associated with a first remote device. The method further includes correlating, by the one or more processors, the first risk information to second risk information to form a risk correlation, based on one or more characteristics of the input data, and determining, by the one or more processors, that the second risk information is associated with a second remote device that is different from the first remote device. The method further includes generating, by the one or more processors, a notification that includes information linking the second risk information to the input data, and transmitting, by a communication unit, the notification to the second remote device.

In another example still, this disclosure is directed to a non-transitory computer-readable storage medium encoded with instructions that, when executed, cause one or more processors of a computing device to perform various operations. The instructions, when executed, cause the one or more processors of the computing device to store input data and a risk data model with respect to the input data to the non-transitory computer-readable storage medium, to evaluate the input data stored to the memory for first risk information associated with a first remote device, and to correlate the first risk information to second risk information to form a risk correlation, based on one or more characteristics of the input data. The instructions, when executed, further cause the one or more processors of the computing device to determine that the second risk information is associated with a second remote device that is different from the first remote device, to generate a notification that includes information linking the second risk information to the input data, and to to transmit, via a communication unit, the notification to the second remote device.

In another example still, this disclosure is directed to an apparatus that includes means for storing input data and a risk data model with respect to the input data, and means for evaluating, by one or more processors, the input data stored to the memory for first risk information associated with a first remote device. The apparatus further includes means for correlating the first risk information to second risk information to form a risk correlation, based on one or more characteristics of the input data, and means for determining that the second risk information is associated with a second remote device that is different from the first remote device. The apparatus further includes means for generating a notification that includes information linking the second risk information to the input data, and means for transmitting the notification to the second remote device.

Computer-based systems configured according to aspects of this disclosure may provide one or more improvements over existing risk modeling technologies. For instance, the computer-based systems of this disclosure may propagate information on risk-generating events across different business units or even business entities. In this way, the computer-based systems of this disclosure may enable risk owners, control owners, and administrators to instigate remediation measures, preventive measures, and escalation procedures expediently after the occurrence of a risk-generating event, instead of constraining the information in a siloed manner within a particular business unit or business entity.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example network system including an administrator-facing device that is communicatively coupled via a network to a risk data modeling device configured to implement various techniques of this disclosure.

FIG. 2 is a block diagram illustrating details of an example implementation of the risk data modeling device illustrated in FIG. 1.

FIG. 3A is a block diagram illustrating an example network system in which the risk data modeling device of FIGS. 1 and 2 generates risk correlation notifications and the risk correlated devices of FIG. 1 perform control measures in response to the risk correlation notifications received from the risk data modeling device, in accordance with the techniques of this disclosure.

FIG. 3B is a block diagram illustrating an example network system in which one or more of the risk-correlated devices of FIGS. 1 and 2 implements risk-owner approval procedures, in accordance with aspects of this disclosure.

FIG. 4 is a block diagram illustrating a use-case scenario in which the risk data modeling device of FIGS. 1-3 correlates risk information stemming from a check-cashing event and generates control update notifications based on the correlated risk information, in accordance with the techniques of this disclosure.

FIG. 5 is a block diagram illustrating an example normalization engine that draws taxonomies and/or nomenclatures from different lexicons associated with different businesses or business units, and generates normalized risk data by applying language processing technology, in accordance with the techniques of this disclosure.

FIG. 6 is a flowchart illustrating an example operation of the risk data modeling device and one of the risk-correlated devices illustrated in FIGS. 1 and 3.

### DETAILED DESCRIPTION

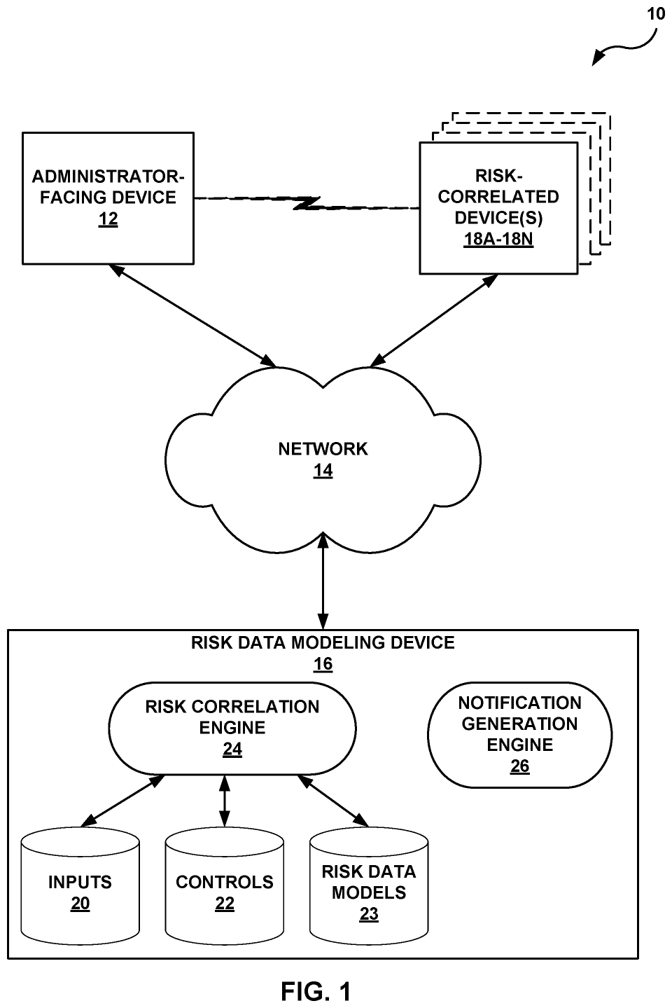

Aspects of the disclosure are described below with reference being made to the accompanying drawings. FIG. 1 is a block diagram illustrating an example network system 10 including an administrator-facing device 12 that is communicatively coupled via a network 14 to a risk data modeling device 16 configured to implement various techniques of this disclosure. Moreover, risk data modeling device 16 is communicatively coupled, via network 14, to one or more risk-correlated devices 18A-18N (hereinafter, “risk-correlated devices 18”). Administrator-facing device 12 may also, optionally, be directly coupled to one or more of risk-correlated devices 18, and the optional nature of the direct connection is illustrated in FIG. 1 using a dashed-line connector.

Administrator-facing device 12 represents one or more network-connected computing hardware modalities that an administrator of an enterprise may operate or otherwise interact with. In one example, administrator-facing device 12 represents one or more banker-operated modalities (e.g., computing terminals) positioned in a bank branch. In this example, the individual banker(s) operating administrator-facing device 12 represent one or more “administrators” as the term is used herein. In another example, administrator-facing device 12 represents one or more airline staff-operated modalities positioned at an airport gate. In this example, the airline staffers operating administrator-facing device 12 at the gate represent one or more administrators in accordance with the description provided herein. Administrator-facing device 12 may, in other use case scenarios, represent a computing hardware modality or a grouping of computing hardware modalities deployed in various other administrator-operated environments, such as in various places of business in which an employee or agent of an enterprise interacts with customers/clients.

Administrator-facing device 12 may receive data either via manual input or via relay from another device communicatively coupled to administrator-facing device 12. As an example of manually-input data, administrator-facing device 12 may receive an input provided by an administrator stationed at the location where administrator-facing device 12 is deployed for enterprise operations. In various examples, administrator-facing device 12 may relay the input to risk data modeling device 16, or may extract metadata describing the input, and send the metadata to risk data modeling device 16. Moreover, in various examples, administrator-facing device 12 may agnostically relay all input information to risk data modeling device 16, or alternatively, may locally implement logic to determine whether and (if so) what type of input-related information to send to risk data modeling device 16. In some instances, in which administrator-facing device 12 locally implements logic to determine whether to send input-related information to risk data modeling device 16, administrator-facing device 12 may, under some circumstances, decline to send input-related information based on a determination that the particular input or some information related to the input is unnecessary or of marginal value to risk data modeling device 16 in terms of performing the techniques of this disclosure.

In the example implementation illustrated in FIG. 1, risk data modeling device 16 is configured to store input-related information received from administrator-facing device 12 (as well as input-related information received from other devices, optionally) as inputs 20. In various examples, risk data modeling device 16 may store all or some portion of inputs 20 remotely, such as by using cloud storage technology. FIG. 1 illustrates risk data modeling device 16 as being configured to store all of inputs 20 locally as a non-limiting example, and it will be appreciated that other storage mechanisms are compatible with the techniques of this disclosure.

Inputs 20 may include information, such as raw data and/or metadata, associated with transactions performed at administrator-facing device 12. In various examples, inputs 20 may include one or more of data points, numerical information, regulations, etc. Moreover, in the example illustrated in FIG. 1, risk data modeling device 16 locally stores controls 22. Controls 22 represent process actions that provide resilience from and/or prevention of various loss events that could result from risks introduced by inputs 20. FIG. 1 illustrates an example in which risk data modeling device 16 locally stores controls 22. In other examples, as explained in more detail below, some or all of controls 22 may be distributed across other devices of network system 10, such as risk-correlated devices 18. In an example where a corresponding input 20 represents a check-cashing event that occurred at administrator-facing device 12, risk data modeling device 16 may invoke and/or fine-tune one or more of controls 22 in response to a risk profile that is associated with the check-cashing nature of the respective input 20.

Again, administrator-facing device 12 represents a computing hardware modality or a clustering of computing hardware modalities deployed at one or more places of business. As such, administrator-facing device 12 may include, be, or be part of a number of different types of computing hardware, such as, but not limited to, desktop computers, laptop computers, network terminals, netbooks, tablet computers, mobile phones (including so-called “smartphones”), automatic teller machines (ATMs), handheld scanning devices (e.g., barcode scanners, QR code scanners, etc.), television (e.g., “smart TVs”), wearable devices with input-receiving capabilities and network connectivity (e.g., a computerized watch, computerized eyewear, computerized gloves, etc.), an automation device or system (e.g., an office/home assistant, an thermostat, or other network-connected appliance), personal digital assistants (PDAs), portable gaming systems, media players with input-relaying capabilities, e-readers, automobile navigation and entertainment systems, or any other types of mobile, non-mobile, wearable, and non-wearable computing devices with the capability to relay information via a data network, such as network 14.

As shown in FIG. 1, administrator-facing device 12 is communicatively coupled to risk data modeling device 16 and to risk-correlated devices 18 via network 14. In various examples, network 14 may represent or include a private network associated with a business (e.g., a financial institution in the check-cashing scenario described above) or other entity that has an interest in the location at which administrator-facing device 12 is deployed. In other examples, network 14 may represent or include a public network, such as the Internet. Although illustrated as a single entity in FIG. 1 as an example, it will be appreciated that network 14 may include a combination of multiple public and/or private networks. For instance, network 14 may represent a private network implemented using public network infrastructure, such as virtual private network (VPN) tunnel implemented over the Internet. As such, network 14 may comprise one or more of a wide area network (WAN) (e.g., the Internet), a local area network (LAN), a VPN, and/or another wired or wireless communication network.

Risk data modeling device 16 may represent one or more back-end devices utilized by the business or entity that controls administrator-facing device 12. While illustrated in FIG. 1 as a single device, it will be appreciated that risk data modeling device 16 may be implemented as a single real server, a single virtual server, or across multiple real and/or virtual servers or other computing devices, either co-located in a single location, data center, or other facility, or distributed across multiple locations, data centers, and potentially widely geographically distributed. Risk data modeling device 16 may include, be, or be part of a server, server system, or a mainframe. In some examples, risk data modeling device 16 may represent a server system that provides enterprise business support, such as risk detection, control modification and notification generation. As such, risk data modeling device 16 may represent one or more real servers and/or or virtual server, and may be or incorporate mainframe computing devices or other back-end computing devices.

As described above, administrator-facing device 12 may relay administrator input and/or generate and transmit metadata information describing an administrator input over network 14 to risk data modeling device 16. Administrator-facing device 12 may facilitate the functioning of risk data modeling device 16 by providing information on events occurring at the administrator's location, such as, but not limited to, customer interactions. In turn, risk data modeling device 16 may implement the techniques of this disclosure to determine cross-business unit or cross-entity risk information based on information from administrator-facing device 12, and to generate one or more notifications to administrators or risk owners based on the risk information.

For instance, risk data modeling device 16 may receive an event alert from administrator-facing device 12, and store the event as a data point to inputs 20. In accordance with the techniques of this disclosure, risk data modeling device 16 may invoke risk correlation engine 24 to evaluate risk information of the event (stored to inputs 20) in a cross-business unit or cross-entity manner. Risk correlation engine 24 may interrelate event information stored to inputs 20 across different business units or business entities. That is, risk correlation engine 24 may form, retrieve, and evaluate risk-related information from multiple systems both internal and external to the business unit or potentially the business entity that controls administrator-facing device 12.

In one use-case scenario, administrator-facing device 12 may detect a check-cashing process, and may transmit information to risk data modeling device 16 based on the check-cashing process. In turn, risk data modeling device 16 may store data representing the check-cashing alert to inputs 20. Moreover, risk data modeling device 16 may invoke one or more of controls 22 that are associated with a check-cashing risk data model of risk data models 23. As one example, risk data modeling device 16 may invoke strengthened authentication procedures (from controls 22) to mitigate or potentially eliminate fraudulent check-cashing risks. In this example, risk data modeling device 16 may transmit a communication over network 14 that causes administrator-facing device 12 to initiate additional identity-verification measures at the bank branch, ATM, or pertinent business location.

In this example, risk correlation engine 24 may link the check-cashing event to various business units, according to techniques of this disclosure. For instance, risk correlation engine 24 may associate the check-cashing event of inputs 20 with different ones of risk data models 23 associated with different business units in addition to the fraudulent check-cashing risk data model associated with an identity protection unit. For example, risk correlation engine 24 may detect a link between the additional identity-verification measures of controls 22 and a customer satisfaction risk data model of risk data models 23 stemming from the additional verification procedures to which a valid check-cashing customer is subjected. In this case, risk correlation engine 24 may associate the inputs and controls of the check-cashing risk data model of risk data models 23 with the customer satisfaction risk data model. Again, the data processed with respect to each of risk data models 23 may include one or more of regulations, numbers, or data points from across one or more business units or business entities. Each of risk data models 23 is configured to be used by risk correlation engine 24 for continual monitoring of the respective inputs 20 and/or the respective controls 22. In turn, risk correlation engine 24 may process one or more of risk data models 23 to output risk predictions, including likelihood of the specific risk and related impacts.

In accordance with techniques of this disclosure, risk data modeling device 16 may adjust the application of one or more of controls 22 based on the risk correlation information generated by risk correlation engine 24. For instance, using the risk correlation information described above with respect to the check-cashing event of inputs 20, risk data modeling device 16 may adjust controls 22 to balance the risk-mitigation process actions associated with both identity verification and customer satisfaction. In accordance with the techniques of this disclosure, risk data modeling device 16 may, subject to various conditions or considerations, adjust at least one of controls 22. In this particular example, risk data modeling device 16 may adjust the escalated identity-verification measures that are customarily triggered in response to a check-cashing alert received from administrator-facing device 12.

For example, risk data modeling device 16 may reduce or potentially eliminate the enhanced identity-verification measures, based on detecting a past history of validated check-cashing transactions with respect to the checking account with which the check is associated. By reducing or eliminating the identity-verification measures to which the customer is subjected, risk data modeling device 16 may use the risk correlation information generated by risk correlation engine 24 to mitigate the risk of diminished customer satisfaction. By mitigating the customer satisfaction risk stemming from the standard use of controls 22 in response to a check-cashing event, risk data modeling device 16 uses the techniques of this disclosure to leverage risk information in one business unit (identity protection) to improve operations in another business unit (customer relations). In this way, risk data modeling device 16 may reduce redundant processing with respect to both identity-verification escalation and customer service complaint input, by correlating risk information across business units/entities and using the correlated risk information to modify cross-business operations.

In accordance with aspects of this disclosure, risk data modeling device 16 may invoke notification generation engine 26 based on the correlated risk information generated by risk correlation engine 24 and the adjustments implemented with respect to controls 22. Notification generation engine 26 may implement the techniques of this disclosure to form communications data (e.g., in the form of network packets) that carries notification information regarding one or more of the inputs 20 that were analyzed for risk, the correlated risk information generated by risk correlation engine 24, or the resulting modifications effected with respect to controls 22. In turn, notification generation engine 26 may transmit the notification(s) to one or more of risk-correlated devices 18 and/or to administrator-facing device 12 over network 14. Because network 14 includes one or more packet-switched network architectures and risk-correlated devices 18 and/or to administrator-facing device 12 represent network-connected computing devices, risk data modeling device 16 and notification generation engine 26 may transmit the notifications over disparate geographic locations using packet-switched network communications technology.

In the check-cashing example described above, notification generation engine 26 may generate and transmit a notification of the control modification to one or more of risk-correlated devices 18 that are controlled by risk owners (e.g., back-end administrators) who are in charge of customer relations and/or customer satisfaction monitoring. Risk-correlated devices 18 may include a variety of computing devices implementing varying amounts and types of computing functionalities. In accordance with the examples described herein, risk-correlated devices 18 may include back-end computing hardware operated by risk managers with varying levels of authority or with different functions within a business, computing hardware modalities positioned at places of customer-facing business, etc. In this way, notification generation engine 26 may eliminate redundant processing by risk-correlated devices 18 that would otherwise be necessary in order to request information on the procedures followed at the check-cashing site, and to analyze the procedures with respect to customer satisfaction.

In the check-cashing example discussed above, notification generation engine 26 may generate and transmit a notification of the control modification to administrator-facing device 12 and/or one or more of risk-correlated devices 18 that are controlled by risk owners who are in charge of identity-protection functions of the business entities. In this manner, in the check-cashing scenario, notification generation engine 26 may eliminate redundant processing by risk-correlated devices 18 that would otherwise be necessary in order to request information on the procedures followed at the check-cashing site, and to analyze the procedures with respect to customer identity-protection. In this manner, risk data modeling device 16 may use the notification-providing functionalities of notification generation engine 26 to reduce processing resource usage and bandwidth consumption that risk-correlated devices 18 would otherwise require, in accordance with the techniques of this disclosure.

In some examples, risk data modeling device 16 may implement various risk-correlation and resulting control modification actions contingent upon risk-owner approval received from one or more of risk-correlated devices 18. For instance, one or more of risk-correlated devices 18 may initiate a risk-owner approval procedure in response to receiving risk correlation notifications from risk data modeling device 16. Based on whether or not the risk-owner approval procedure results in an approval or a denial, risk data modeling 16 may correlate or decorrelate various risk information, and may implement or decline modifications to the customary control procedures represented by controls 22.

By correlating risks and/or implementing updates to controls 22 based on approval/denial information received from risk-correlated devices 18, risk data modeling device 16 may implement the techniques of this disclosure to conserve computing resources by reducing redundant evaluations of risk correlations, while leveraging the benefits of already-performed risk correlation evaluations. Similarly, risk data modeling device 16 may thereby avoid redundant instances of notification generation engine 26 generating and transmitting notifications if a risk correlation has been denied by a risk owner operating any of risk-correlated devices 18. In this way, risk data modeling device 16 may implement the techniques of this disclosure to conserve computing resources and bandwidth by reducing redundant evaluations of risk correlations and reducing notification generation and transmission, while leveraging the benefits of already-performed risk correlation evaluations.

In some instances, one or more of risk-correlated devices 18 may transmit an indication or suggestion of additional risk correlation back to risk data modeling device 16. In these instances, risk data modeling device 16 may evaluate whether to update the currently-implemented one of risk data models 23 to correlate the risk information indicated in the recommendation, or to decorrelate the risks (effectively denying or declining the recommendation). Subject to approving the risk-correlation recommendation, risk data modeling device 16 may transmit a risk correlation notification to one or more affected risk-correlated devices 18 and/or update the one of risk data models 23 to correlate future events similar to the input that triggered the recommendation.

As shown in this example, risk data modeling device 16 may implement the techniques of this disclosure to crowdsource risk correlation information (e.g., in the form of recommendations) to update the risk data model for a certain type of risk-triggering input. In this way, risk data modeling device 16 may improve the operations of risk-correlated devices using risk-owner input, thereby supplementing the functioning of risk correlation engine 24 and/or notification generation engine 26 without further taxing the computing resources allotted to risk correlation engine 24 and/or notification engine 26.

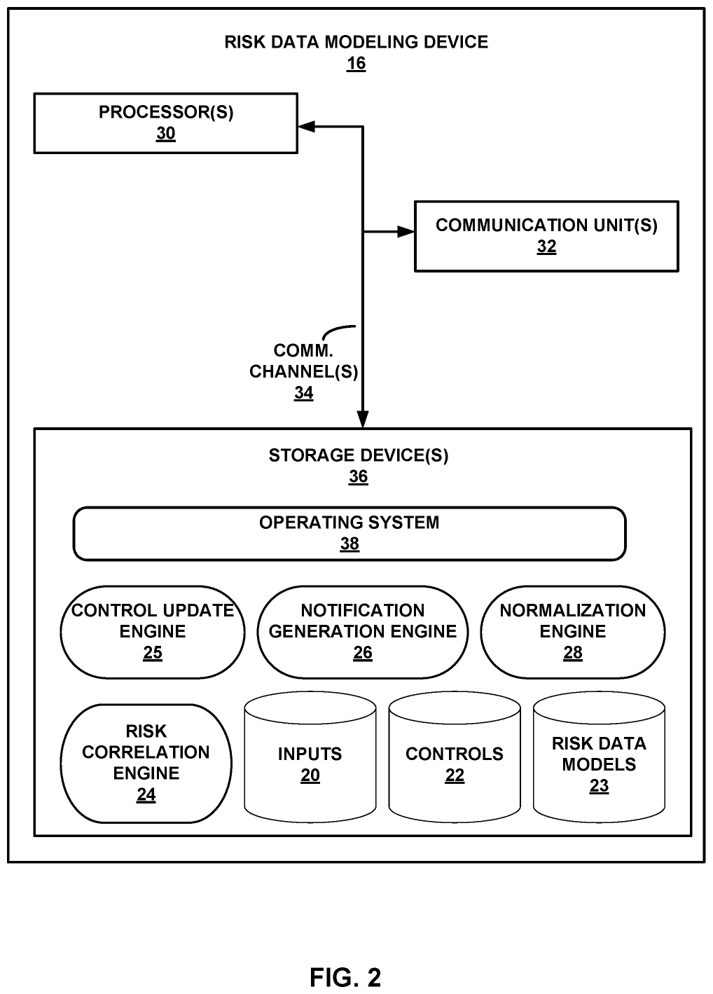

FIG. 2 is a block diagram illustrating details of an example implementation of risk data modeling device 16 illustrated in FIG. 1. Although shown in FIG. 2 with respect to a single device for ease of illustration, the functionalities described with respect to risk data modeling device 16 may be distributed across multiple devices at different locations. Risk data modeling device 16 may also form any component or system that includes a processor (e.g., processor(s) 30) or other suitable computing environment for executing instructions and, for example, need not include one or more of the elements shown in FIG. 2.

As shown in the example of FIG. 2, risk data modeling device 16 may include one or more processors 30, one or more communication units 32, one or more communication channels 34, and one or more storage devices 36. Each of components 30, 32, and 36 may be interconnected (physically, communicatively, and/or operatively) for inter-component communications. In some examples, communication channel(s) 34 may include a system bus, network connection, inter-process communication data structure, or any other channel for communicating data. As one example in FIG. 2, components 30, 32, and 36 may be coupled by one or more communication channel(s) 34.

Processors 30, in one example, are configured to implement functionality and/or process instructions for execution within risk data modeling device 16. For example, processors 30 may be capable of processing instructions stored in storage device(s) 36. Examples of processors 30 may include, any one or more of a microprocessor, a controller, a digital signal processor (DSP), an application specific integrated circuit (ASIC), a field-programmable gate array (FPGA), or equivalent discrete or integrated logic circuitry.

One or more storage devices 36 may be configured to store information within risk data modeling device 16 during operation. Storage device(s) 36, in some examples, are described as a computer-readable storage medium and/or as one or more computer-readable storage devices. In some examples, storage devices 36 comprise temporary memory, meaning that a primary purpose of storage device(s) 36 is not long-term storage. Storage device(s) 36, in some examples, are described as a volatile memory, meaning that storage device(s) 36 do not maintain stored contents when the computer is turned off. Examples of volatile memories include random access memories (RAM), dynamic random access memories (DRAM), static random access memories (SRAM), and other forms of volatile memories known in the art. In some examples, storage device(s) 36 are used to store program instructions for execution by processors 30. Storage device(s) 36, in one example, are used by software or applications running on risk data modeling device 16 to temporarily store information during program execution.

Storage device(s) 36, in some examples, also include one or more computer-readable storage media. Examples of such computer-readable storage media may include a non-transitory computer-readable storage medium, and various computer-readable storage devices. Storage device(s) 36 may be configured to store larger amounts of information than volatile memory. Storage device(s) 36 may further be configured for long-term storage of information. In some examples, storage device(s) 36 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

In the implementation illustrated in FIG. 2, risk data modeling device 16 also includes one or more communication units 32. Risk data modeling device 16 may utilize communication units 36 to communicate with external devices via one or more networks, such as one or more wireless networks. For instance, risk data modeling device 16 may use communication units 32 to communicate with client device 2 of FIG. 1. Communication units 32 may include a network interface card, such as an Ethernet card, an optical transceiver, a radio frequency transceiver, or any other type of device that can send and receive information. Other examples of such network interfaces may include Bluetooth®, 3G 4G and WiFi® radios as well as Universal Serial Bus (USB)-connectible network interface devices. In some examples, risk data modeling device 16 utilizes communication units 32 to wirelessly communicate with an external device.

Risk data modeling device 16 may use communication unit(s) 32 to implement various communication-based functionalities described above. As one example, communication unit(s) 32 may facilitate the receipt, decapsulation, and interpretation of packet-based event alerts from administrator-facing device. As another example, communication unit(s) 32 may facilitate the formation, encapsulation and transmission of packet-based notifications generated by notification generation engine 26 to one or more of risk-correlated devices 18 and/or administrator-facing device 12.

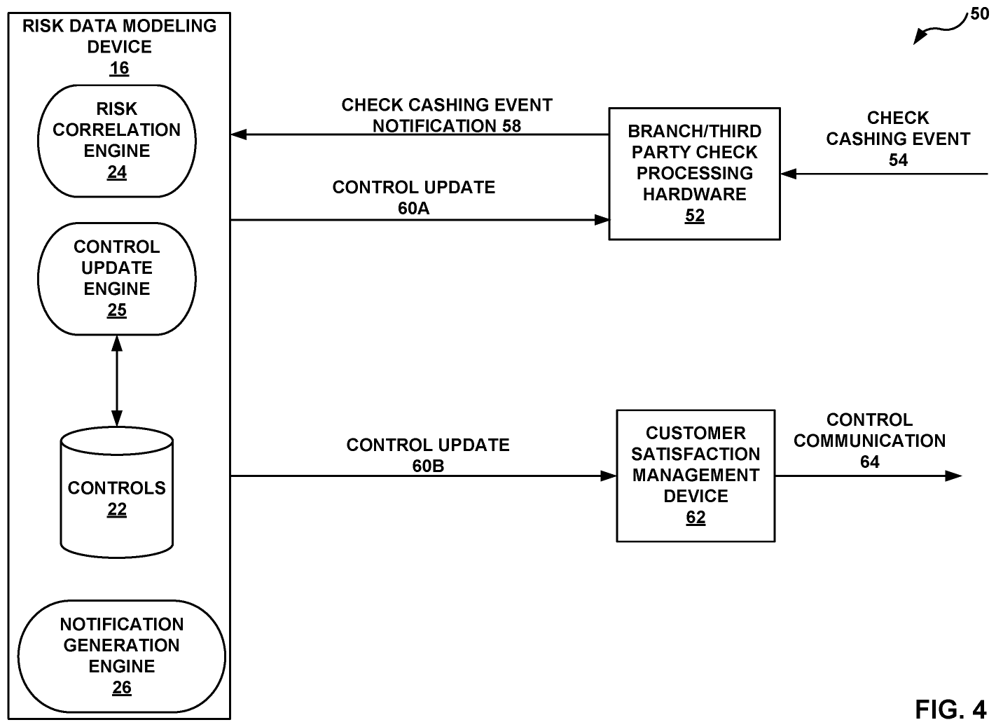

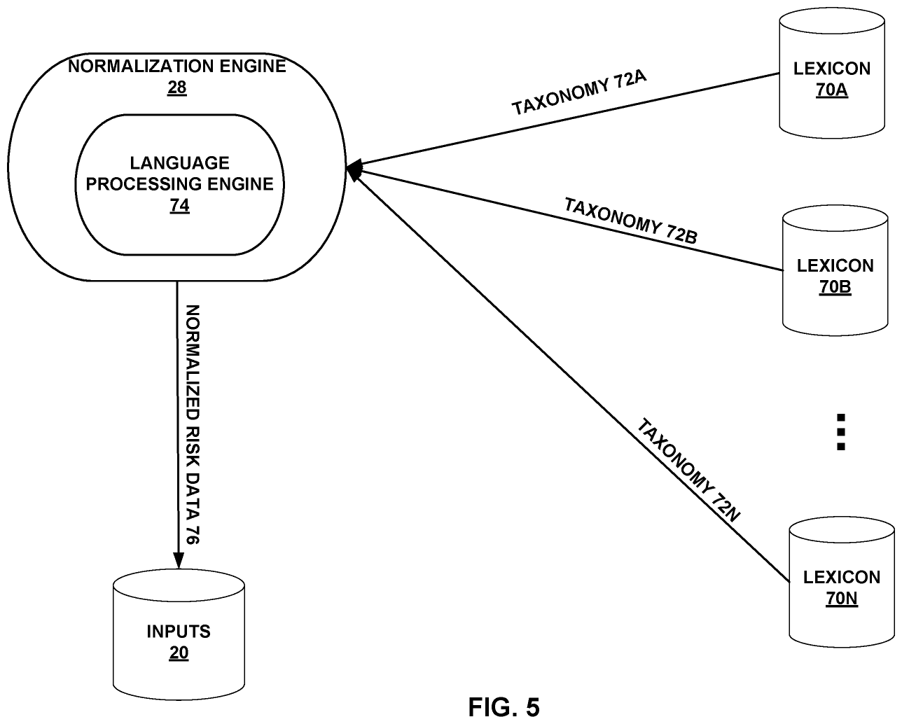

Risk data modeling device 16 may also implement one or more aspects of operating system 38. Operating system 38, in some examples, controls the operation of components of risk data modeling device 16. For example, operating system 38 may facilitate the communication of various units illustrated in storage devices 36 with processors 30 and communication unit(s) 32. As shown in FIG. 2, storage device(s) 36 may include or otherwise facilitate in storing and implementing one or more of inputs 20, controls 22, risk data models 23, risk correlation engine 24, control update engine 25, notification generation engine 26, or normalization engine 28. Control update engine 25 is configured to implement modifications to controls 22 in response to various events. Control update engine 25 is described in further detail below with respect to FIG. 4. Normalization engine 28 is configured to normalize inputs 20 and controls 22 for use by risk correlation engine 24, and is normalization engine 28 described in further detail below with respect to FIG. 5. In various implementations, the functionalities described with respect to a single unit may be distributed among multiple units, or conversely, the functionalities described with respect to multiple units herein may be combined into a fewer number of units.

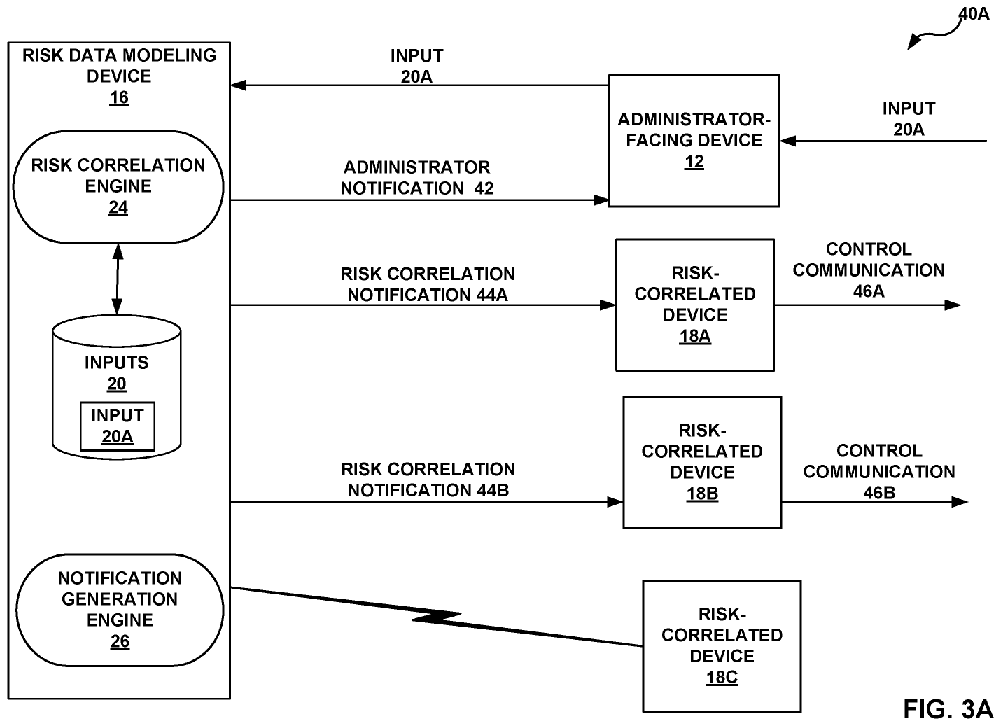

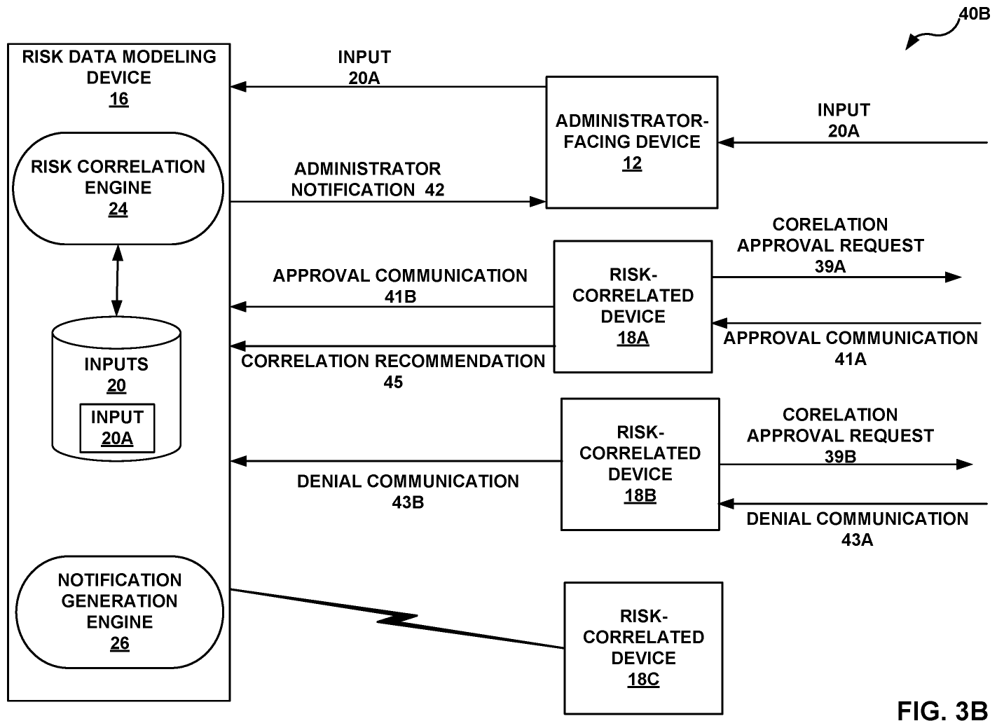

FIG. 3A is a block diagram illustrating an example network system 40A in which the implementation of controls 22 (illustrated in FIG. 1) is distributed across one or more of risk-correlated devices 18. Network system 40A may function similarly to network system 10 illustrated in FIG. 1, except that the risk-mitigation process actions represented by controls 22 in FIG. 1 are instigated at one or more of risk-correlated devices 18. That is, risk data modeling device 16 may provide notifications of correlated risk information to the pertinent one(s) of risk-correlated devices 18 in accordance with various aspects of this disclosure. In turn, those of risk-correlated devices 18 that receive correlated risk information from risk data modeling device 16 may determine whether or not to modify the customary control action(s) triggered in response to the risk event, and if so, may implement the modification to the control action(s).

As illustrated in FIG. 3A, administrator-facing device 12 may receive input 20A that represents a place-of-business event at the site where administrator-facing device 12 is deployed. In the example illustrated in FIG. 3A, administrator-facing device 12 may relay input 20A to risk data modeling device 16. Risk data modeling device 16 may store the event information of input 20A to inputs 20. In turn, risk correlation engine 24 may correlate risk information of input 20A across various business units/entities associated with two or more of risk-correlated devices 18.

In the example illustrated in FIG. 3A, notification generation engine 26 may implement the techniques of this disclosure to generate notifications that alert individual risk owners to the instigation of a risk that is specific to each respective risk-owner. As one example, notification generation engine 26 may generate administrator notification 42 that informs a risk owner operating administrator-facing device 12 of operational and/or technical risks arising from the event represented by input 20A.

Additionally, notification generation engine 26 may generate individual risk correlation notifications that are customized for each risk owner operating any of risk-correlated devices 18 that are associated with one of the correlated risks. In the example of FIG. 3A, risk correlation engine 24 may correlate risks stemming from input 20A to functionalities performed by risk-correlated device 18A and risk-correlated device 18B. As such, in this particular example, notification generation engine 26 may generate notifications that inform the risk owners controlling each of risk-correlated device 18A and risk-correlated device 18B about the specific risk introduced to each risk-owner, arising out of input 20A. In the particular example of FIG. 3A, risk correlation engine 24 may not identify any risk correlation between input 20A and the risk ownership of risk correlated device 18C, and so notification generation engine 26 may not generate any risk correlation notification with respect to risk-correlated device 18C.

As shown in FIG. 3A, notification generation engine 26 may generate risk correlation notification 44A and cause risk data modeling device 16 to transmit risk correlation notification 44A to risk-correlated device 18A. Notification generation 26 may generate risk correlation notification 44B and cause risk data modeling device 16 to transmit risk correlation notification 44B to risk-correlated device 18B. Notification generation engine 26 may generate risk correlation notification 44A such that risk correlation notification 44A includes information on a risk that input 20A triggers with respect to the operations of risk-correlated device 18A. Similarly, notification generation engine 26 may generate risk correlation notification 44B such that risk correlation notification 44B includes information on a risk that input 20A triggers with respect to the operations of risk-correlated device 18B. As shown, in this particular example, notification generation engine 26 may not generate any notification for risk-correlated device 18C in relation to input 20A, based on risk correlation engine 24 not detecting a correlated risk between input 20A and the operations of risk-correlated device 18C. In this way, notification generation engine 26 may facilitate the operations of certain ones of risk-correlated devices 18 by generating and transmitting risk correlation notifications 44 to the specific risk correlated devices 18, while conserving network bandwidth and processing resources by avoiding the generation and transmission of notifications with respect to other ones of risk-correlated devices 18 that may not be affected by risks originating from input 20A.

In one example, administrator-facing device 12 may comprise various computing modalities deployed at an airport gate. For instance, administrator-facing device 12 may represent a grouping of a network-connected computing terminal and one or more handheld scanners. In this example, input 20A may represent flight crew information. Flight crew information may include one or more of a number of crew members who have checked in for the flight, the assignments for the individual flight crew members, current locations for the crew members, etc. In turn, risk data modeling device 16 may be configured to evaluate the flight crew information of input 20A using a flight operations-based risk data model to determine any potential risks arising from the specific flight crew information contained in input 20A.

In this example, based on any operational or technical risks that risk data modeling device identifies from the data of input 20A, risk correlation engine 24 may correlate the risk information across different business units/entities. For instance, based on the keyword matching and AI tools implemented by risk correlation engine 24 with respect to the data of input 20A, risk data modeling device 16 may identify a customer dissatisfaction risk based on understaffing and/or sub-optimal assignments with respect to the flight crew members. As another example, risk data modeling device 16 may identify a risk of regulatory noncompliance or guideline noncompliance, based on the keyword matching and AI tools implemented by risk correlation engine 24 with respect to the data of input 20A and on understaffing and/or sub-optimal assignments with respect to the flight crew members.

In an example where risk-correlated device 18A is operated by a risk owner who is in charge of customer relations and goodwill, notification generation engine 26 may generate risk correlation notification 44A to indicate the correlated customer dissatisfaction risk to the risk owner operating risk-correlated device 18A. In turn, risk-correlated device 18A may trigger one or more control process actions in response to receiving the risk correlation notification 44A. For instance, risk-correlated device 18A may generate control communication 46A, which, in the case of airline customer service, may be an email with a flight voucher to one or more of the passengers on the flight. In this way, notification generation engine 26 may generate risk correlation notification 44A, and risk-correlated device 18A may generate control communication 46A, in such a way as to mitigate future bandwidth wastage and resource wastage that could possibly result from a spike in customer satisfaction complaints.

In this example use-case scenario, risk-correlated device 18B may be operated by a risk owner who is in charge of regulatory compliance. Notification generation engine 26 may generate risk correlation notification 44B to indicate any possible regulatory noncompliance risk to the risk owner operating risk-correlated device 18B. In turn, risk-correlated device 18B may trigger one or more control process actions in response to receiving the risk correlation notification 44B. For instance, risk-correlated device 18B may generate control communication 46B, which, in the case of airline regulatory compliance, may be a request for corrective measures which is sent to a legal department. In this way, notification generation engine 26 may generate risk correlation notification 44B, and risk-correlated device 18B may generate control communication 46B, in such a way as to mitigate future bandwidth wastage and resource wastage that could possibly result from an increase in received regulatory noncompliance warnings and/or complaints.

As shown in FIG. 3A, in this specific example, notification generation engine 26 does not generate a risk correlation notification for risk-correlated device 18C. For example, risk correlation engine 24 may not detect any risk correlation between the flight crew information of input 20A and the functions performed by risk-correlated device 18C. For example, risk-correlated device 18C may be operated by a risk owner who is in charge of refueling operations. In this example, risk correlation engine 24 may not detect a refueling-related risk based on the flight crew information included in input 20A. As such, notification generation engine 26 may not generate any risk correlation notification with respect to risk-correlated device 18C, at least as it pertains to input 20A. In this manner, notification generation engine 26 may implement the techniques of this disclosure in such a way as to conserve computing resources (at both risk data modeling device 16 and at risk correlated device 18C) and to conserve network bandwidth by avoiding the generation and transmission of notifications to certain devices that risk data modeling device 16 determines are likely to be unaffected by the information of a particular input (input 20A in this case).

FIG. 3B is a block diagram illustrating network system 40B, in which one or more of risk-correlated devices 18 implements risk-owner approval procedures, in accordance with aspects of this disclosure. Various risk-correlation and resulting control modification actions of this disclosure may be implemented contingent upon risk-owner approval received at one or more of risk-correlated devices 18. Each of risk-correlated devices 18A and 18B may initiate a risk-owner approval procedure in response to receiving risk correlation notifications 44A and 44B, respectively. As shown in FIG. 3B, risk-correlated device 18A may generate and output correlation approval request 39A, and risk-correlated device 18B may generate and output correlation approval request 39B to the respective risk owners.

The arrows showing the communication direction of correlation approval requests 39A and 39B illustrate that risk-correlated devices 18A and 18B may output correlation approval requests 39A and 39B to users (e.g., the risk owners who control the respective ones of risk-correlated devices 18A and 18B). In various examples, risk-correlated devices 18A and 18B may output correlation approval requests 39A and 39B directly to the risk owners (e.g., via a GUI or other interface), or indirectly, such as via emails/messages to other devices (e.g., user terminals or mobile devices) operated by the respective risk owners. Based on whether or not the risk-owner approval procedure results in an approval or a denial, risk data modeling device 16 or risk-correlated devices 18 may either maintain the customarily-implemented controls, or may modify the customary control procedures.

In the example illustrated in FIG. 3B, in response to risk correlation notification 44A of FIG. 3A and receiving an approval communication 41A from the risk owner, risk-correlated device 18A sends approval communication 41B to risk data modeling device 16. In response to risk correlation notification 44B of FIG. 3A and receiving a denial communication 43A from the risk owner, risk-correlated device 18B sends denial communication 43B to risk data modeling device 16. That is, in the particular use-case scenario of network system 40B, the risk owner operating risk-correlated device 18A approves the risk correlation indicated in risk correlation notification 44A, while the risk owner operating risk-correlated devices 18B denies the risk correlation indicated in risk correlation notification 44B. In turn, risk-correlated device 18A may generate control communication 46A as described in FIG. 3A, based on receiving approval communication 41A. Conversely, risk-correlated device 18B may decline to generate control communication 46B as described in FIG. 3A, based on receiving denial communication 43A.

Moreover, risk-correlated devices 18A and 18B may communicate the approval/denial status of each correlation request back to risk data modeling device 16. In the example of FIG. 3B, risk data modeling device 16 receives approval communication 41B from risk-correlated device 18A, and receives denial communication 43B from risk-correlated device 18B. Based on receiving approval communication 41B from risk-correlated device 18A, risk data modeling device 16 may update the current risk data model for input 20A, such that future events similar to the event of input 20A automatically trigger a risk correlation notification similar to risk correlation notification 44A. That is, risk data modeling device 16 may implement machine learning to update the risk data model, thereby avoiding redundant instances of risk correlation engine 24 reevaluating information similar to that of input 20A for risk correlation to the functions of risk-correlated device 18A. In this way, risk data modeling device 16 may implement the techniques of this disclosure to conserve computing resources by reducing redundant evaluations of risk correlations, while leveraging the benefits of already-performed risk correlation evaluations.

Conversely, based on receiving denial communication 43B from risk-correlated device 18B, risk data modeling device 16 may update the current risk data model for input 20A, such that future events similar to the event of input 20A are automatically left decorrelated from the functions of risk-correlated device 18B. As such, risk data modeling device 16 may eliminate future instances of risk correlation engine 24 evaluating data similar to that of input 20A and may eliminate future instances of notification generation engine 26 generating and transmitting notifications similar to risk correlation notification 44B. That is, risk data modeling device 16 may implement machine learning to update the risk data model, thereby avoiding redundant instances of risk correlation engine 24 reevaluating information similar to that of input 20A for risk correlation to the functions of risk-correlated device 18B.

Similarly, in the automatic decorrelation example discussed with respect to risk correlation notification 44B and denial communication 43B, risk data modeling device 16 may thereby avoid redundant instances of notification generation engine 26 generating and transmitting notifications similar to risk correlation notification 44B if a risk correlation has been denied (e.g., via denial communication 43A, 43B) by a risk owner operating risk-correlated device 18B. In this way, risk data modeling device 16 may implement the techniques of this disclosure to conserve computing resources and bandwidth by reducing redundant evaluations of risk correlations and reducing notification generation and transmission, while leveraging the benefits of previously-performed risk correlation evaluations.

In some instances, one or more of risk-correlated devices 18 (e.g., risk-correlated device 18A) may transmit an indication or suggestion of additional risk correlation back to risk data modeling device 16. For instance, the risk owner operating risk-correlated device 18A may input a recommendation to correlate the data of input 20A to the functions of risk-correlated device 18C. Risk-correlated device 18A may transmit the risk owner-provided correlation recommendation 45 to risk data modeling device 16. In turn, risk data modeling device 16 may evaluate whether to update the currently-implemented risk data model to correlate risk information between input 20A and the functionalities implemented by risk-correlated device 18C.

Again, the communication from risk-correlated device 18A to risk data modeling device 16 to relay the risk owner-input recommendation is illustrated as correlation recommendation 45 in FIG. 3B. In this example, the risk owner operating risk-correlated device 18A may input a recommendation to correlate the data of input 20A to the functions of risk-correlated device 18C. In turn, risk-correlated device 18A may generate correlation recommendation 45 based on the risk owner-provided indication, and transmit correlation recommendation 45 to risk data modeling device 16. Risk data modeling device 16 may evaluate whether to update the currently-implemented risk data model to correlate risk information between input 20A and the functionalities implemented by risk-correlated device 18C.

Subject to the risk-correlation recommendation (or correlation recommendation 45) with respect to risk-correlated device 18C being approved for a risk data model update, risk data modeling device 16 may transmit a risk correlation notification to risk-correlated device 18C and/or update the risk data model to correlate future events similar to that of input 20A to the functionalities of risk-correlated device 18C. As shown in this example, risk data modeling device 16 may implement the techniques of this disclosure to crowdsource risk correlation information (e.g., in the form of recommendations) to update the risk data model for a certain type of risk-triggering input. In this way, risk data modeling device 16 may improve the operations of risk-correlated devices using risk-owner input, thereby supplementing the functioning of risk correlation engine 24 and/or notification generation engine 26 without further taxing the computing resources allotted to risk correlation engine 24 and/or notification engine 26

FIG. 4 is a block diagram illustrating an example network system 50 in which risk modeling device 16 processes a check-cashing input using the risk correlation and notification generation techniques of this disclosure. In the particular use-case scenario illustrated in FIG. 4, a bank branch or third party's check processing hardware 52 (hereinafter, check processing hardware 52) represents an example of administrator-facing device 12 illustrated in FIG. 1. Check processing hardware 52 may represent one or more computing hardware modalities, such as network computing terminals, ATMs, etc. Check processing hardware 52 may receive an input in the form of check cashing event 54. Check cashing event 54 may represent the input of a personal check or cashier's check for an immediate exchange for cash. Check processing hardware 52 may relay information on the check-cashing nature of check cashing event 54 to risk data modeling device 16.

In the example of FIG. 4, check processing hardware 52 sends check cashing event notification 58 to risk data modeling device 16. Check cashing event notification 58 may, in various examples, represent an alert, based on the risks generally associated with check cashing, whether at a bank branch or at a third party check cashing facility. Risk data modeling device 16 may analyze the information included in check cashing notification 58 for cross-business risk correlation, in accordance with the techniques of this disclosure. In the example illustrated in FIG. 4, risk data modeling device 16 includes control update engine 25.

For instance, risk correlation engine 24 may correlate the identity-protection risks generally associated with check cashing to the risk of customer dissatisfaction associated with the customary control of escalating identity verification procedures typically triggered in a check-cashing scenario. In some examples, control update engine 25 may modify the escalated identity verification procedures based on a determination that the account number associated with the check being cashed is associated with a threshold number of previously-verified check-cashing events. In turn, control update engine 25 may reduce or potentially eliminate the escalated identity verification procedures (e.g., fingerprint collection, etc.) that the administrator operating check processing hardware 52 would typically instigate at the customer-facing site. That is, based on risk correlation engine 24 correlating risks in response to a detected event, control update engine 25 may make decisions with respect to changing one or more of controls 22. In turn, control update engine 25 may implement the corresponding changes with respect to controls 22, thereby causing risk data modeling device 16 to alter or balance the impact on the correlated business units or entities.

In turn, control update engine 25 may cause notification generation engine 26 to generate and transmit control update 60A to check processing hardware 52. In this particular example, control update 60A may represent a communication informing the administrator that the escalated identity-verification procedures are to be bypassed with respect to check cashing event 54. Additionally, notification generation engine 26 may send control update 60B to customer satisfaction management device 62. Customer satisfaction management device 62 represents one of risk-correlated devices 18 illustrated in FIGS. 1 and 3, and may be operated by a risk-owner who is in charge of customer relations. In this example, notification generation engine 26 may configure control update 60B to provide information on the bypassed identity-verification procedures with respect to check cashing event 54.

In turn, customer satisfaction management device 62 may generate control communication 64, which may represent a log entry or other tracking information of customer satisfaction-oriented control changes that risk data modeling device 16 has implemented within a certain period of time. Customer satisfaction management device 62 may send control communication 64 to one or more entities, such as a record-keeping department, to maintain a history of correlated risk-based control updates and notifications implemented by risk data modeling device 16 in accordance with the techniques described herein.

FIG. 5 is a conceptual diagram illustrating an example normalization engine 28 configured to normalize inputs 20 and controls 22 for use by risk correlation engine 24 of FIGS. 1-4. In some examples, normalization engine 68 may be included in risk data modeling device 16 of FIGS. 1-4, or in another computing device associated with network 14 of FIG. 1 and in communication with risk data modeling device 16. As shown in FIG. 5, normalization engine 28 may have access to various lexicons, denoted as lexicons 70A-70N (“lexicons 70”). Normalization engine 28 may use information accessed from two or more of lexicons 70 to initialize the risk correlation procedures of this disclosure. Each of lexicons 70 may include terminologies, jargon, definitions, etc. (represented in FIG. 5 as taxonomies 72A-72N, or collectively, “taxonomies 72”). Each of taxonomies 72 may be customized to fit a single business unit/entity. For instance, lexicon 70A may store a taxonomy 72A associated with banking identity protection, lexicon 70B may store a taxonomy 72B associated with customer relations, and so on.

In the example of FIG. 5, risk correlation engine 24 includes a language processing engine 74. Upon detecting an input that triggers a risk alert (e.g., as received by risk data modeling device 16 from administrator-facing device 12), risk correlation engine 24 may invoke language processing 74 to perform keyword matching and natural language processing to normalize information from two or more of taxonomies 72, in relation to the data of the risk-triggering input. In some examples, language processing engine 74 may include artificial intelligence (AI) or machine learning capabilities such that it will continually learn and improve its keyword matching to find terms that are equivalent or related across the different lexicons 70. In the check-cashing use-case scenario described above, language processing engine 74 may normalize the check-cashing information across the identity protection aspects of taxonomy 72A and the customer satisfaction aspects of taxonomy 72B.

In turn, risk correlation engine 24 may output normalized risk data 76 to be stored as normalized input data in inputs 20. Risk correlation engine 24 and notification generation engine 26 may use normalized risk data 76 to determine risk correlations and to generate notifications to various devices, such as one or more of risk-correlated devices 18 and/or administrator-facing device 12. Normalization engine 28 may similarly normalize control data for storage in controls 22. In this way, normalization engine 28 and/or language processing engine 74 may implement one or more of keyword matching, AI tools, or machine learning capabilities to normalize one or more of inputs 20 and/or controls 22, to facilitate the performance of risk correlation engine 24.

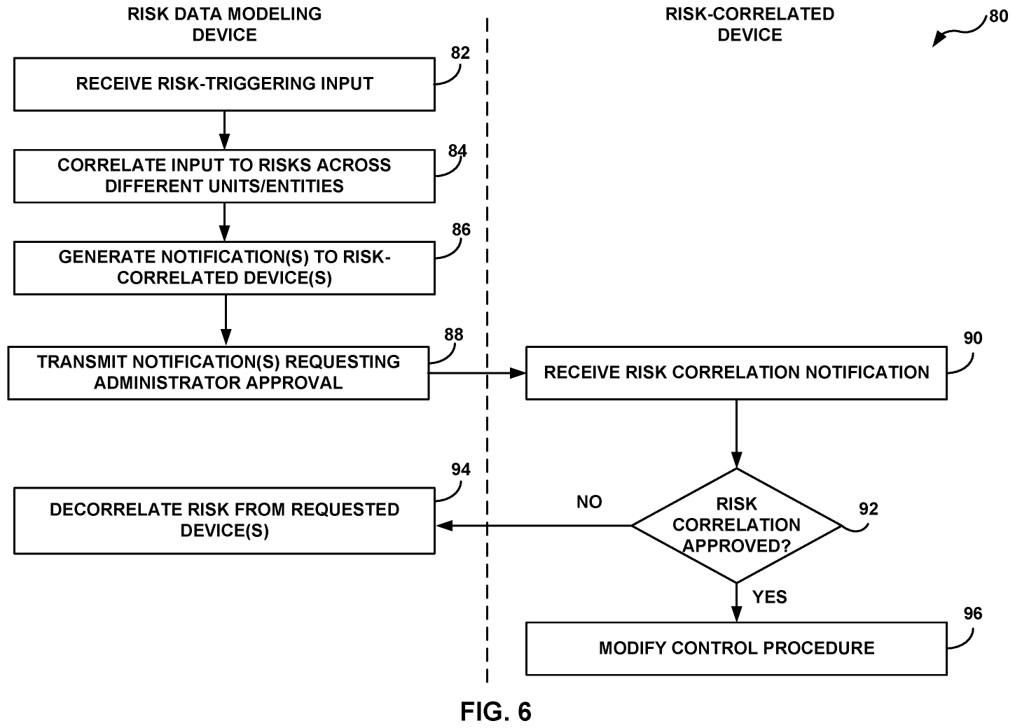

FIG. 6 is a flowchart illustrating an example process 80 by which risk data modeling device 16 and one of risk-correlated devices 18 (risk-correlated device 18A as an example) may perform various techniques of this disclosure. Process 80 may begin when risk data modeling device 16 receives a risk-triggering input from administrator-facing device 12 (82). In turn, risk data modeling device 16 may invoke risk correlation engine 24 to correlate the input to one or more risks across different business units/entities associated with risk-correlated devices 18 (84). Based on the correlation(s) identified by risk correlation engine 24, notification generation engine 26 may generate one or more notifications to respective ones of risk-correlated devices 18 (86).

In turn, risk data modeling device 16 may use communication unit(s) 32 to transmit the notification to risk-correlated device 18A (88). In this example, notification generation engine 26 may generate the notification as a request for administrator approval of the risk correlation. Risk-correlated device 18A may receive the correlation notification 44A transmitted by risk data modeling device 16 (90). Risk-correlated device 18A may determine whether or not the risk correlation included in the notification receives an administrator approval (decision block 92). For instance, risk-correlated device 18A may generate an approval request (e.g., correlation approval request 39A) or other communication that elicits administrator input, or may leverage standing instructions/instruction heuristics from past administrator inputs to determine whether or not the risk correlation is administrator-approved.

If the risk correlation to risk-correlated device 18A does not receive administrator approval (‘NO’ branch of decision block 92), then risk-correlated device 18A may transmit a denial notification to risk data modeling device 16. Based on the denial notice (e.g., denial communication 43) received from risk-correlated device 18A, risk data modeling device 16 may decorrelate any risk associated with the functions of risk-correlated device 18A from the data of the input received from administrator-facing device 12 (94). As such, neither risk data modeling device 16 nor risk-correlated device 18A may modify any of the control procedures associated with the input, based on the input being decorrelated from any risks associated with the risk-ownership of risk-correlated device 18A.

If the risk correlation to risk-correlated device 18A receives administrator approval (YES' branch of decision block 92), then risk-correlated device 18A may modify one or more control procedures associated with the correlated risk (96). It will be appreciated that in various examples, risk-correlated device 18A may modify a locally-implemented control process action, may notify risk data modeling device 16 of a modification to a centrally-implemented control process action, or some combination of these procedures.

As illustrated by process 80 of FIG. 6, various risk-correlation and resulting control modification actions may be implemented contingent upon risk-owner approval received from one or more of risk-correlated devices 18. Described with respect to the implementation illustrated in FIG. 3B, each of risk-correlated devices 18A and 18B may initiate a risk-owner approval procedure in response to receiving risk correlation notifications 44A and 44B, respectively. Based on whether or not the risk-owner approval procedure results in an approval or a denial, risk data modeling device 16 or risk-correlated devices 18 may either maintain the customarily-implemented controls, or may modify the customary control procedures.

Moreover, risk-correlated devices 18A and 18B may communicate the approval/denial status back to risk data modeling device 16. In one example (as shown in FIG. 3B), risk data modeling device 16 may receive a risk-owner approval (e.g., via approval communication 41B) from risk-correlated device 18A, and may receive a risk-owner denial (e.g., via denial communication 43B) from risk-correlated device 18B. Based on approval communication 41B received from risk-correlated device 18A, risk data modeling device 16 may update the current risk data model for input 20A, such that future events similar to the event of input 20A automatically trigger a risk correlation notification similar to risk correlation notification 44A. That is, risk data modeling device 16 may implement machine learning to update the risk data model, thereby avoiding redundant instances of risk correlation engine 24 reevaluating information similar to that of input 20A for risk correlation to the functions of risk-correlated device 18A. In this way, risk data modeling device 16 may implement the techniques of this disclosure to conserve computing resources by reducing redundant evaluations of risk correlations, while leveraging the benefits of already-performed risk correlation evaluations.

Based on denial communication 43B received from risk-correlated device 18B, risk data modeling device 16 may update the current risk data model for input 20A, such that future events similar to the event of input 20A are automatically left decorrelated from the functions of risk-correlated device 18B. As such, risk data modeling device 16 may eliminate future instances of risk correlation engine 24 evaluating data similar to that of input 20A and may eliminate future instances of notification generation engine 26 generating and transmitting notifications similar to risk correlation notification 44B. That is, risk data modeling device 16 may implement machine learning to update the risk data model, thereby avoiding redundant instances of risk correlation engine 24 reevaluating information similar to that of input 20A for risk correlation to the functions of risk-correlated device 18B. Similarly, risk data modeling device 16 may thereby avoid redundant instances of notification generation engine 26 generating and transmitting notifications similar to risk correlation notification 44B if a risk correlation has been denied by a risk owner operating risk-correlated device 18B. In this way, risk data modeling device 16 may implement the techniques of this disclosure to conserve computing resources and bandwidth by reducing redundant evaluations of risk correlations and reducing notification generation and transmission, while leveraging the benefits of already-performed risk correlation evaluations.

In some instances, one or more of risk-correlated devices 18 (e.g., risk-correlated device 18A) may transmit an indication or suggestion of additional risk correlation back to risk data modeling device 16. For instance, the risk owner operating risk-correlated device 18A may input a recommendation to correlate the data of input 20A to the functions of risk-correlated device 18C. Risk-correlated device 18A may transmit the risk owner-provided indication to risk data modeling device 16. In turn, risk data modeling device 16 may evaluate whether to update the currently-implemented risk data model to correlate risk information between input 20A and the functionalities implemented by risk-correlated device 18C.

Subject to the risk-correlation recommendation with respect to risk-correlated device 18C being approved for a risk data model update, risk data modeling device 16 may transmit a risk correlation notification to risk-correlated device 18C and/or update the risk data model to correlate future events similar to that of input 20A to the functionalities of risk-correlated device 18C. As shown in this example, risk data modeling device 16 may implement the techniques of this disclosure to crowdsource risk correlation information (e.g., in the form of recommendations) to update the risk data model for a certain type of risk-triggering input. In this way, risk data modeling device 16 may improve the operations of risk-correlated devices using risk-owner input, thereby supplementing the functioning of risk correlation engine 24 and/or notification generation engine 26 without further taxing the computing resources allotted to risk correlation engine 24 and/or notification engine 26.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a mobile computing device, a wearable computing device, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A computing device comprising:
a communication unit;
a memory configured to store input data and a risk data model with respect to the input data;
one or more processors in communication with the memory and the communication unit, the one or more processors being configured to:
evaluate the input data stored to the memory for first risk information associated with a first remote device controlled by a first risk owner;
correlate the first risk information to second risk information to form a risk correlation, based on one or more characteristics of the input data;
determine that the second risk information is associated with a second remote device that is different from the first remote device, the second remote device being controlled by a second risk owner that is different from the first risk owner; and
generate an approval request with respect to the risk correlation that includes information linking the second risk information to the input data;
transmit, via the communication unit, the approval request to the second remote device controlled by the second risk owner;
receive, via the communication unit, a denial of the risk correlation from the second remote device controlled by the second risk owner; and
update the risk data model to decorrelate the input data from the second risk information in response to receiving the denial of the risk correlation from the second remote device controlled by the second risk owner.

2. The computing device of claim 1, wherein the input data is associated with a check cashing event associated with the first remote device, wherein the second risk information is associated with identity protection for a customer who initiated the check cashing event, and wherein the one or more processors are further configured to
maintain one or more control process actions associated with the first risk information associated with the check cashing event in response to receiving the denial of the risk correlation.

3-4. (canceled)

5. The computing device of claim 1, wherein to correlate the first risk information to the second risk information to form the risk correlation, the one or more processors are configured to perform at least one of keyword matching or metadata matching with respect to the first risk information and the second risk information.

6. The computing device of claim 5,
wherein the memory is further configured to store a first lexicon associated with the first risk information and a second lexicon associated with the second risk information, and
wherein the one or more processors are further configured to perform the one of the keyword matching or the metadata matching by mapping one or more entries of the first lexicon to one or more corresponding entries of the second lexicon.

7. The computing device of claim 1, wherein the one or more processors are configured to:
normalize the input data with respect to a first taxonomy associated with the first risk information and with respect to a second taxonomy associated with the second risk information.

8. The computing device of claim 1, wherein the risk correlation between the first risk information and the second risk information is a first risk correlation, and wherein the one or more processors are further configured to:
receive, via the communication unit, from the second remote device, a recommendation of a second risk correlation, wherein the second risk correlation is between the first risk information and third risk information associated with a third remote device, and wherein the recommendation is based on the notification transmitted to the second remote device; and
update the risk data model stored to the memory based on the second risk correlation, wherein the updated risk data model includes a link between the input data and the third remote device.

9. (canceled)

10. The computing device of claim 1, wherein the computing device comprises one or more of a real server, a virtual server, a distributed server system, or a mainframe.

11. A method comprising:
storing, to a memory, input data and a risk data model with respect to the input data;
evaluating, by one or more processors, the input data stored to the memory for first risk information associated with a first remote device controlled by a first risk owner;
correlating, by the one or more processors, the first risk information to second risk information to form a risk correlation, based on one or more characteristics of the input data;
determining, by the one or more processors, that the second risk information is associated with a second remote device that is different from the first remote device, the second remote device being controlled by a second risk owner that is different from the first risk owner; and
generating, by the one or more processors, an approval request with respect to the risk correlation that includes information linking the second risk information to the input data;
transmitting, via a communication unit, the approval request to the second remote device controlled by the second risk owner;
receiving, by the one or more processors, via the communication unit, a denial of the risk correlation from the second remote device controlled by the second risk owner; and
updating, by the one or more processors, the risk data model to decorrelate the input data from the second risk information in response to receiving the denial of the risk correlation from the second remote device controlled by the second risk owner.

12. The method of claim 11, wherein the input data is associated with a check cashing event associated with the first remote device, wherein the second risk information is associated with identity protection for a customer who initiated the check cashing event, the method further comprising
maintaining, by the one or more processors, one or more control process actions associated with the first risk information associated with the check cashing event in response to receiving the denial of the risk correlation.

13-14. (canceled)

15. The method of claim 11, wherein correlating the first risk information to the second risk information to form the risk correlation comprises performing, by the one or more processors, at least one of keyword matching or metadata matching with respect to the first risk information and the second risk information.

16. The method of claim 15, further comprising:
storing, to the memory, a first lexicon associated with the first risk information and a second lexicon associated with the second risk information,
wherein performing the one of the keyword matching or the metadata matching comprises mapping, by the one or more processors, one or more entries of the first lexicon to one or more corresponding entries of the second lexicon.

17. The method of claim 11, further comprising:
normalizing, by the one or more processors, the input data with respect to a first taxonomy associated with the first risk information and with respect to a second taxonomy associated with the second risk information.

18. The method of claim 11, wherein the risk correlation between the first risk information and the second risk information is a first risk correlation, the method further comprising:
receiving, by the one or more processors, via the communication unit, a recommendation of a second risk correlation from the second remote device, wherein the second risk correlation is between the first risk information and third risk information associated with a third remote device, and wherein the recommendation is based on the notification transmitted to the second remote device; and
updating, by the one or more processors, the risk data model stored to the memory based on the second risk correlation, wherein the updated risk data model includes a link between the input data and the third remote device.

19. (canceled)

20. A non-transitory computer-readable storage medium encoded with instructions that, when executed, cause one or more processors of a computing device to:
store, to the non-transitory computer-readable storage medium, input data and a risk data model with respect to the input data;
evaluate the input data stored to the non-transitory computer-readable storage medium for first risk information associated with a first remote device controlled by a first risk owner;
correlate the first risk information to second risk information to form a risk correlation, based on one or more characteristics of the input data;
determine that the second risk information is associated with a second remote device that is different from the first remote device, the second remote device being controlled by a second risk owner that is different from the first risk owner; and
generate an approval request with respect to the risk correlation that includes information linking the second risk information to the input data;
transmit, via a network, the approval request to the second remote device controlled by the second risk owner;
receive, via a communication unit, a denial of the risk correlation from the second remote device controlled by the second risk owner; and
update the risk data model to decorrelate the input data from the second risk information in response to receiving the denial of the risk correlation from the second remote device controlled by the second risk owner.

21. The computing device of claim 1, wherein the denial of the risk correlation is included in a denial communication generated by the second remote device as part of a risk-owner approval procedure performed with respect to the second risk owner based on the approval request.

22. The method of claim 11, wherein the denial of the risk correlation is included in a denial communication generated at the second remote device as part of a risk-owner approval procedure performed with respect to the second risk owner based on the approval request.

23. The non-transitory computer-readable storage medium of claim 20, wherein the denial of the risk correlation is included in a denial communication generated at the second remote device as part of a risk-owner approval procedure performed with respect to the second risk owner based on the approval request.

24. The computing device of claim 1, wherein the risk data model is configured to be used for continual monitoring of a plurality of inputs that includes the input data stored to the memory.

25. The non-transitory computer-readable storage medium of claim 20, further encoded with instructions that, when executed, cause the one or more processors to normalize the input data with respect to a first taxonomy associated with the first risk information and with respect to a second taxonomy associated with the second risk information.
